(19) United States
(12) Patent Application Publication
(10) Pub. No.: US 2020/0319831 A1
(43) Pub. Date: Oct. 8, 2020

(54) IMAGE PROCESSING APPARATUS, METHOD, AND PROGRAM

(71) Applicant: CANON KABUSHIKI KAISHA, Tokyo (JP)

(72) Inventor: Yusuke Kobana, Kawasaki-shi (JP)

(21) Appl. No.: 16/818,421

(22) Filed: Mar. 13, 2020

(30) Foreign Application Priority Data
Apr. 2, 2019 (JP) 2019-070466

(51) Int. Cl. G06F 3/12; H04N 1/00; H04N 1/44

(52) U.S. Cl. CPC G06F 3/1238; G06F 3/1222; H04N 1/4406; H04N 1/00225

(57) ABSTRACT

An image processing apparatus is an image processing apparatus that supports a mail function which is able to be used based on a verification of an access token corresponding to a login user, and comprises a processing unit that starts processing for verifying the validity of an access token corresponding to the login user between the success in login to the image processing apparatus and the completion of scanning processing that follows a scanning instruction corresponding to the login; and a transmitting unit that transmits mail data including image data obtained by the scanning processing to a mail server by using the mail function in accordance with the result for the verification of the access token.

### BACKGROUND I/F THE INVENTION

### Field of the Invention

The present invention relates to an image processing apparatus, a method, and a program.

### Description of the Related Art

An image processing apparatus such as an MFP (Multi-Function Peripheral) having a function for converting an image read by a scanner into a file of a specified image format and transmitting the file to a destination on a network is known.

Additionally, OAuth authentication is known as one of protocols related to the authorization of API (Application Program Interface) access. By using the OAuth authentication, the authorization of API access necessary for cooperation between a plurality of servers can be easily performed. This OAuth authentication is also used as an authentication method used in performing mail transmission by using an external SMTP (Simple Network Management Protocol) server.

An access token used in OAuth authentication is issued when a client application receives a login authentication operation and authorization operation from a user through a resource server. If the access token becomes invalid due to a reason such as an expiration of the access token, the reissue of the access token is required. One way to perform this reissue is a client application transmitting a refresh token that has been issued simultaneously with the access token from an authorization server. Additionally, if the reissue of the access token by using the refresh token has failed, in the client application, the reissue of the access token is required by receiving the login authentication operation and authorization operation from the user to the authorization server again.

For example, Japanese Patent Application Laid-Open No. 2014-197819 suggests simultaneously transmitting scanned image data and an access token, which is authorization information that has been acquired in advance, to a server, after the scanner receives a scan execution instruction and then scanning is completed.

However, in the authorization processing by using the access token after scanning has completed as disclosed in Japanese Patent Application Laid-Open No. 2014-197819, the overall processing time required from scanning to the transmission completion increases.

### SUMMARY I/F THE INVENTION

An image processing apparatus according to an embodiment is an image processing apparatus that supports a mail function which is able to be used based on a verification of an access token corresponding to a login user, the image processing apparatus comprising: a memory storing instructions; and a processor executing the instructions causing the image processing apparatus to: start processing for verifying the validity of an access token corresponding to the login user between the success in login to the image processing apparatus and the completion of scanning processing that follows a scanning instruction corresponding to the login; and transmit mail data including image data obtained by the scanning processing to a mail server by using the mail function in accordance with the result for the verification of the access token.

Further features of the present invention will become apparent from the following description of experimental artifacts with reference to the attached drawings.

### BRIEF DESCRIPTION I/F THE DRAWINGS

FIG. 1 illustrates a configuration example of an image processing system according to the first embodiment.

FIG. 2 is a block diagram illustrating an example of a hardware configuration of MFP.

FIG. 3 illustrates an example of a configuration of an operation unit.

FIG. 4 illustrates an example of a home screen.

FIG. 5 illustrates an example of an operation screen of a SEND application.

FIG. 6 illustrates an example of an address book screen.

FIG. 7 illustrates an example of a scan in-progress screen.

FIG. 8 illustrates an example of a job reception completion screen.

FIG. 9 illustrates an example of a screen showing a failure in a reissue of an access token.

FIG. 10 illustrates an example of a screen showing a login authentication in OAuth authentication.

FIG. 11 illustrates an example of an authorization screen in OAuth authentication.

FIG. 12 illustrates a command sequence between software modules of the MFP according to the first embodiment.

FIG. 13 shows the continuation of FIG. 12.

FIG. 14 is a flow chart illustrating an operation example of a UI control unit according to the first embodiment.

FIG. 15 shows the continuation of FIG. 14.

FIG. 16 is a flow chart illustrating an operation example of the scanner control unit according to the first embodiment.

FIG. 17 is a flow chart illustrating an operation example of a transmission control unit according to the first embodiment.

FIG. 18 illustrates a command sequence between the software modules of the MFP according to the second embodiment.

FIG. 19 shows the continuation of FIG. 18.

FIG. 20 illustrates an example of a screen showing OAuth authentication in-progress.

FIG. 21 is a flow chart illustrating an operation example of the UI control unit according to the second embodiment.

FIG. 22 shows the continuation of FIG. 21.

### DESCRIPTION I/F THE EMBODIMENTS

Embodiments of the present invention will be described below with reference to the drawings and the like. Note that the following embodiments do not limit the claimed invention, and not all of the combinations of the features described in the embodiments are necessarily essential to the solution of the invention.

### First Embodiment

In the first embodiment, a description will be given of a configuration that prevents an increase in a processing time for an entire transmission if an access token is invalid in OAuth authentication and reissue by using a refresh token is required.

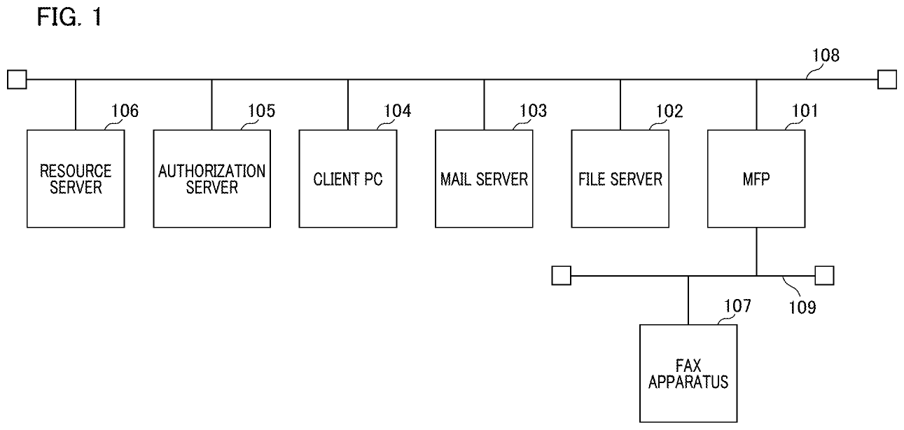

FIG. 1 illustrates a configuration example of an image processing system including an image processing apparatus according to the first embodiment. The image processing system shown in FIG. 1 includes an MFP 101 to serve as an example of the image processing apparatus, a file server 102, a mail server 103, a client personal computer (PC) 104, an authorization server 105, and a resource server 106. The components of the image processing system are connected to each other via a network 108. Additionally, the MFP 101 is connected to a facsimile (FAX) apparatus 107 via a telephone line 109. Thus, the FAX apparatus 107 can transmit and receive images by using a facsimile function to and from the MFP 101 via the telephone line 109.

The MPF 101 of the present embodiment is, for example, a full-color image processing apparatus that employs an electrophotographic system, and has copy, FAX, and printer functions. The MFP 101 also has a SEND function and an Internet fax (hereinafter, referred to as an “IFAX”) function. The SEND function is a function for transmitting image files read by a scanner to a computer device. The IFAX function is a function for communicating an image that has been read by a scanner between devices of the same type and printing an image received by the communication.

The file server 102 is a server installed to share files on the network 108. The file server 102 can accumulate the image files transmitted from the MFP 101 in conformity to a communication protocol such as FTP, SMB, or WebDAV.

The mail server 103 is a server installed to deliver an e-mail. The mail server 103 communicates with the MFP 101, the client PC 104, and the like in conformity to the SMTP and the POP3 protocols, and delivers mail data to which the image file is attached.

The client PC 104 is a computer used by an ordinary user for a business and the like, and includes hardware resources and software resources, and an OS (Operating System) included in the software resources controls execution and the like of an application. For example, the client PC 104 can display an image scanned by the MFP 101 by executing an application of the image viewer and can print the images by the MFP 101 by using a printer function. The client PC 104 can transmit and receive e-mail to and from the mail server 103 by executing an e-mail application. Note that the number of client PCs 104 connected to the network 108 is not limited to the example shown in FIG. 1, and may be two or more.

The authorization server 105 is a server that receives authorization information from a client application in OAuth authentication and issues an access token and a refresh token when it determines that the authorization information is valid.

The resource server 106 is a server that provides a mail transmission API using OAuth authentication. When a mail transmission request is performed by the client application through the API, the resource server 106 verifies the validity of the access token and, if the access token is valid, the resource server 106 executes mail transmission.

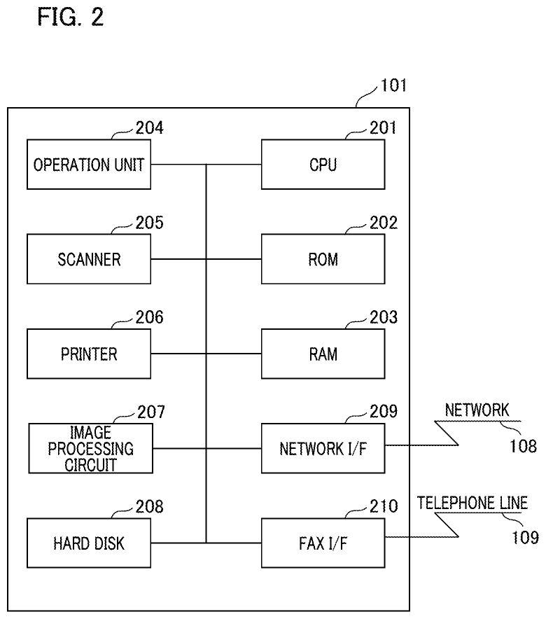

FIG. 2 is a block diagram illustrating an example of the hardware configuration of the MFP 101. As shown in FIG. 2, the MFP 101 includes a CPU 201, a ROM 202, a RAM 203, an operation unit 204, a scanner 205, a printer 206, an image processing circuit 207, a hard disk 208, a network I/F 209, and a FAX I/F 210. CPU is an abbreviation for “Central Processing Unit”, and ROM is an abbreviation for “Read Only Memory”. RAM is an abbreviation for “Random Access Memory”.

The CPU 201 loads software (program) stored in the ROM 202 or the hard disk 208, or downloaded from the network 108 into the RAM 203 as required and executes it. Thus, the CPU 201 integrally controls each component connected to the system bus.

The ROM 202 is a nonvolatile storage medium that stores data, various programs, and various information tables. The RAM 203 functions as a main memory or a work area of the CPU 201. The operation unit 204 is a device that receives various operations performed by a user.

The scanner 205 is a device that reads an image on a document and sequentially outputs the read image data for each page. The printer 206 prints an image based on the image data on a recording medium. For example, the printer 206 is an electrophotographic printing device including an exposure unit, a transfer unit, a fixing unit, and the like.

The image processing circuit 207 includes, for example, a large-capacity image memory, an image rotation circuit, a resolution resizing circuit, an encoding/decoding circuit such as MH, MR, MMR, JBIG, JPEG, and the like, and can execute various types of image processing such as shading, trimming, masking, and the like. Although not shown in FIG. 2, the scanner 205, the printer 206, and the image processing circuit 207 are connected by a high-speed video bus that is different from a CPU bus from the CPU 201, so that image data can be transferred at a high speed.

The hard disk 208 is a large volume capacity medium connected by I/F such as SCSI and IDE, and stores, for example, image data and a program. The network I/F 209 is an interface circuit for connecting to the network 108. The FAX I/F 210 is an interface circuit that controls facsimile communication with an external device on the telephone line 109.

Here, in the MFP 101, the image data read by the scanner 205 can be processed by the image processing circuit 207 and the image data can be transmitted to an external device via the telephone line 109. The MPF 101 can generate an image file in a format such as JPEG, PDF or TIFF from the image data by the image processing circuit 207. The MFP 101 can transmit the generated image file from the network I/F 209 in conformity to a communication protocol such as SMTP, FTP, or SMB.

In the following description, a function for transmitting an image file such as JPEG, PDF, TIFF and the like in conformity to the SMTP protocol is referred to as a “mail transmission function”. Additionally, a function for transmitting an image file in conformity to FTP and SMB is referred to as a “file transmission function”. The IFAX function specified in RFC 2305 exists as one of the above SEND functions, and the facsimile function is realized by transmitting and receiving an image file attached to an email between devices of the same type.

Additionally, in the IFAX function, a TIFF file specified in RFC 3949 is generated in the image processing circuit 207 from the image data read by the scanner 205, and the TIFF file is transmitted by the SMTP protocol. When an e-mail containing a TIFF file is received by using the SMTP or POP3 function, the image processing circuit 207 of the MPF 101, which is a receiving destination, changes an internal image format image. Subsequently, the printer 206 prints the image.

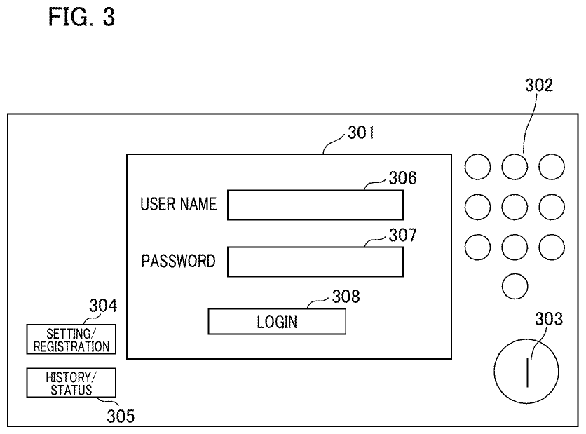

FIG. 3 illustrates an example of the configuration of the operation unit 204. The operation unit 204 includes an LCD display panel 301, and a numeric keypad 302, a start key 303, a “Setting/Registration” button 304, and a “History/Status” button 305 each serve as physical buttons.

The LCD display panel 301 is configured by combining a display device and a touch panel. The LCD display panel 301 displays an input unit on the panel using software, and detects a user's operation on the input unit. In the example of FIG. 3, a login screen for the user to log in to the MFP is displayed on the LCD display panel 301. Items on the login screen include a user name input form 306, a password input form 307, and a “Login” button 308.

The user name input form 306 receives an input of a user name necessary for login to the MFP 101. The password input form 307 receives the input of a password associated with a user name input in the user name input form 306. The “Login” button 308 is a button for executing login authentication to the MFP 101 with the contents that have been input in the user name input form 306 and the password input form 307.

The numeric keypad 302 is a button that receives numerical input from 0 to 9. The start key 303 is a button that receives an instruction to start a job. The “Setting/Registration” button 304 is a button that receives an operation for calling a setting screen of the apparatus. The “History/Status” button 305 is a button that receives an operation for calling the history/status of the job. The operation unit 204 detects a user's operation from the LCD display panel 301 and various buttons, and smoothly executes the user's operation.

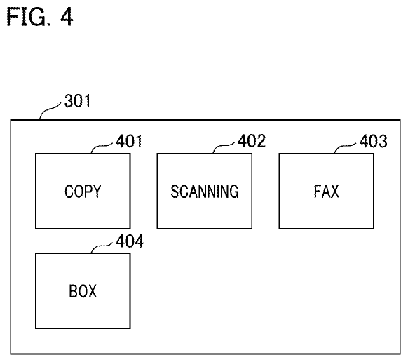

FIG. 4 illustrates an example of a home screen. The home screen is displayed on the LCD display panel 301 when the user successfully logs in to the MFP 101. The user who successfully logs in is also referred to as a “login user”. The home screen includes items of a “Copy” button 401, a “Scan” button 402, a “FAX” button 403, and a “Box” button 404.

The “Copy” button 401 is a button that receives an operation for calling an operation screen of a copy application. The “Scan” button 402 is a button that receives an operation for calling an operation screen of a SEND application. The “FAX” button 403 is a button that receives an operation for calling an operation screen of a FAX application. The “Box” button 404 is a button that receives an operation for calling an operation screen of a box function.

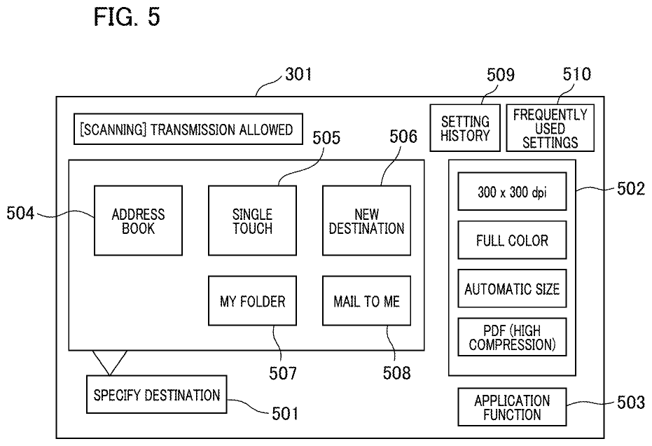

FIG. 5 illustrates an example of the operation screen of the SEND application. The operation screen of the SEND application is displayed on the LCD display panel 301 when the user presses the “Scan” button 402 shown in FIG. 4. The operation screen of the SEND application includes items related to a destination and items related to application settings.

The items related to the destination in the operation screen of the SEND application include a “Specify Destination” button 501 for inputting a transmission destination and a button group (504 to 508) that specifies a transmission destination. When the “Specify Destination” button 501 is pressed, a group of buttons that specifies the transmission destination is displayed on the screen. The transmission destination may be input by any button.

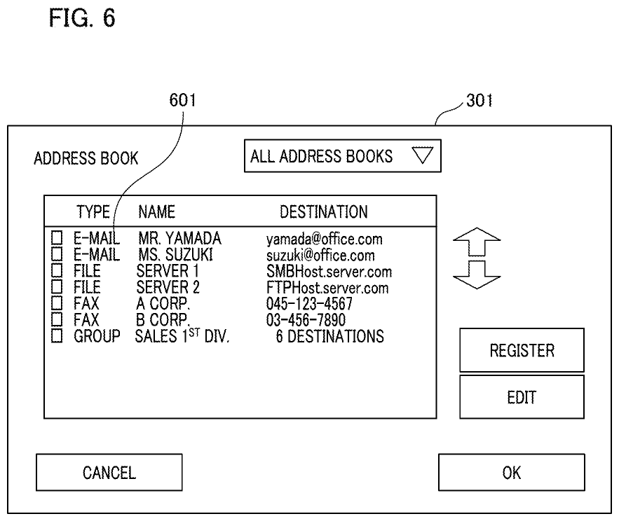

An “Address Book” button 504 is a button that receives an operation for displaying an address book screen. The address book screen will be described below with reference to FIG. 6. A “Single-touch” button 505 is a button that receives an operation for displaying a single-touch button selection screen. In the single-touch button selection screen, when the user presses a button for a desired destination from registered single-touch buttons, the destination is set as a transmission destination.

A “New Destination” button 506 is a button that receives an operation for displaying a transmission type selection screen. In the transmission type selection screen, a destination setting screen corresponding to the transmission type selected by the user is displayed, and a transmission destination is set by inputting the necessary information for each transmission type. A “My Folder” button 507 is a button that receives an operation for setting a folder of a file server associated with the user to serve as a transmission destination. A “Mail to Me” button 508 is a button that receives an operation for setting a mail address associated with the user as a transmission destination.

Items related to application settings in the operation screen of the SEND application include the following. A transmission basic setting button 502 is a button that receives an operation for setting a reading condition such as a reading resolution and a reading color mode, and a transmission file format. An “Application Function” button 503 is, for example, a button that receives an operation for invoking various detailed settings during reading and transmission.

A “Setting History” button 509 is a button that receives an operation for calling the setting history screen. In the setting history screen, the history of settings performed by the user in the past can be called and set as transmission settings. A “Frequently Used Settings” button 510 is a button that receives an operation for calling a frequently used setting screen. In the frequently used setting screen, for example, a button corresponding to the stored transmission settings is displayed.

FIG. 6 illustrates an example of an address book screen. The address book screen is displayed on the LCD display panel 301 when the user presses the “Address Book” button 504 on the operation screen of the SEND application shown in FIG. 5. The address book screen includes items of a destination list 601 in which registered addresses are listed. On the address book screen, a desired destination is selected from the destinations listed in the destination list 601 by a user. Thus, the destination selected by the user is set as a transmission destination. As shown in the destination list 601 of FIG. 6, the destination is associated with any one of, for example, a fax number, a mail address, and an IP address of a server.

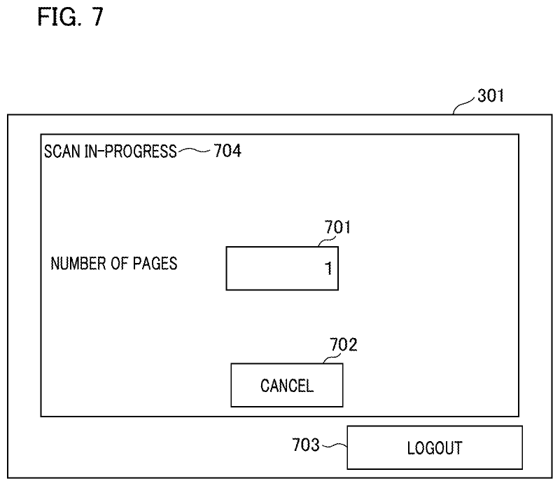

FIG. 7 illustrates an example of a scan in-progress screen. The scan in-progress screen is displayed on the LCD display panel 301 when the user presses the start key 303 in a state in which the transmission destination is being selected.

The scan in-progress screen includes items of a scanning page number display field 701, a “Cancel” button 702, a “Logout” button 703, and a display 704 indicating that a scan is in progress. The scanning page number display field 701 indicates the number of scanned pages. The “Cancel” button 702 is a button that receives an operation for canceling the scanning processing. The “Logout” button 703 is a button that receives an operation for closing the scan in-progress screen (or the job reception completion screen) and displaying the login screen of FIG. 3. When the “Logout” button 703 is pressed in the scan in-progress screen, the scanning processing is cancelled.

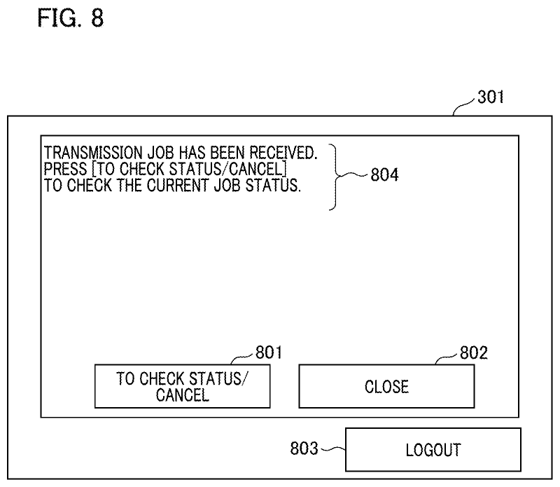

FIG. 8 illustrates an example of the job reception completion screen. The job reception completion screen transitions from the scan in-progress screen after the scanning is completed, and is displayed on the LCD display panel 301. The job reception completion screen includes items of a “To Status Check/Stop” button 801, a “Close” button 802, a “Logout” button 803, and a message display 804 indicating that a transmission job has been received.

The “To Status Check/Stop” button 801 is a button that displays a job status and receives an operation that is cancelled by a user as necessary. The “Close” button 802 is a button that receives an operation for closing the job reception completion screen and displaying the operation screen of the SEND application shown in FIG. 5. The “Logout” button 803 is a button that receives an operation that closes the job reception completion screen and displays the login screen shown in FIG. 3. When the “Logout” button 803 is pressed on the job reception completion screen, the transmission processing continues without cancellation.

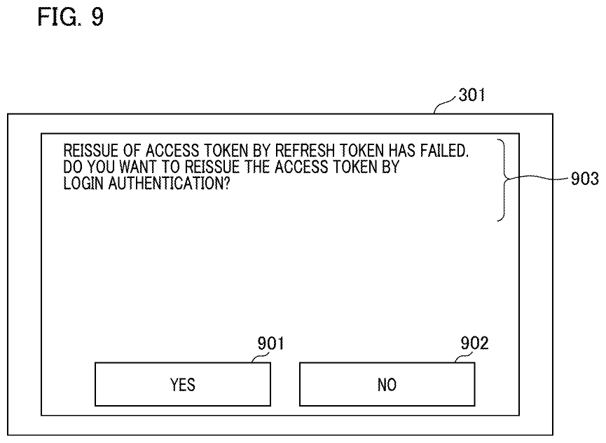

FIG. 9 illustrates an example of a screen showing a failure to reissue the access token. The screen showing a failure to reissue the access token is displayed on the LCD display panel 301 when the reissue of the access token by using the refresh token in OAuth authentication fails.

The screen showing a failure in the reissue of the access token includes items of a “YES” button 901, a “NO” button 902, and a message display 903. The message display 903 includes a text indicating that the reissue of the access token by using the refresh token has failed, and a text confirming whether or not the reissue of the access token by login authentication is necessary. The “YES” button 901 is a button that receives an operation for reissuing the access token by login authentication. The “NO” button 902 is a button that receives an operation that reissue of the access token by login authentication will not be performed.

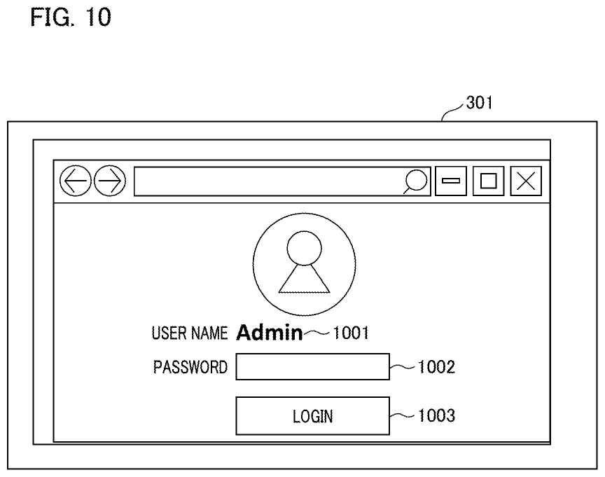

FIG. 10 illustrates an example of a login authentication screen in OAuth authentication. The login authentication screen is displayed on the LCD display panel 301 and includes items of a user name display field 1001, a password input form 1002, and a “Login” button 1003.

The user name display field 1001 indicates a user name used during login authentication to the authorization server 105. FIG. 10 illustrates an example in which admin is displayed as the user name in the user name display field 1001. The password input form 1002 receives the input of a password associated with a user name display field 1001. The “Login” button 1003 is a button that receives an operation for performing login authentication to the authorization server 105 by using the user name in the user name display field 1001 and the input information (password) in the password input form 1002.

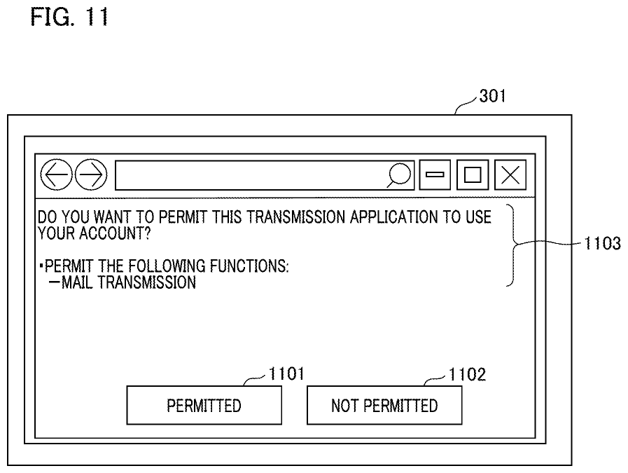

FIG. 11 illustrates an example of an authorization screen in OAuth authentication. The authorization screen is displayed on the LCD display panel 301 and includes items such as a “Permitted” button 1101, a “Not Permitted” button 1102, and a message display 1103.

The message display 1103 includes a text confirming the permission for use of an account to the SEND application and a text indicating a function to be permitted (For example, mail transmission). The “Permitted” button 1101 is a button that receives from the user an operation for permitting mail transmission by OAuth authentication in the SEND application. The “not permitted” button 1102 is a button that receives from the user an operation for not permitting mail transmission by OAuth authentication in the SEND application.

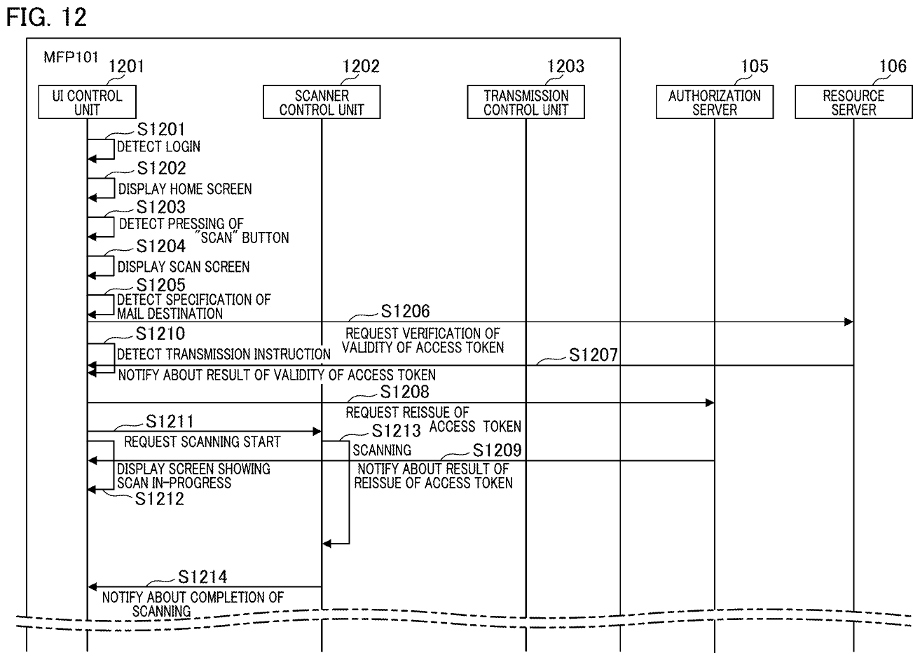

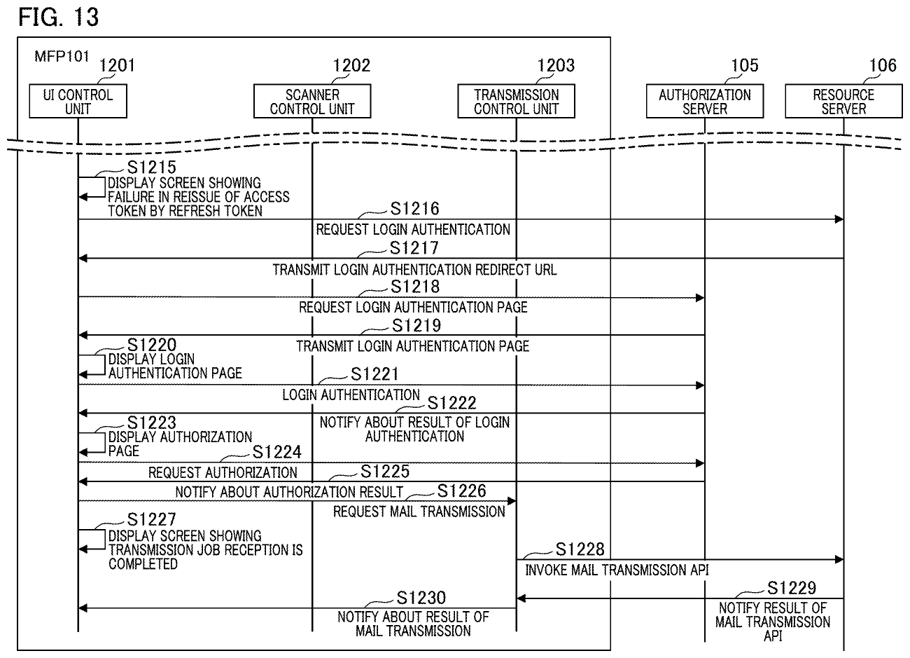

FIG. 12 and FIG. 13 illustrate a command sequence between software modules installed in the MFP 101 of the first embodiment.

Here, a UI control unit 1201, a scanner control unit 1202, and a transmission control unit 1203 shown in FIG. 12 and FIG. 13 are all software modules of the MFP 101. The functions of these software modules are realized when the CPU 201 of the MFP 101 reads a program stored in the ROM 202 or the hard disk 208 into the RAM 203 and then the program is executed.

The UI control unit 1201 is a software module that controls the operation unit 204 of the MFP 101. For example, the UI control unit 1201 transmits a scanning start request to the scanner control unit 1202. When receiving the scan completion notification from the scanner control unit 1202, the UI control unit 1201 requests the transmission control unit 1203 to transmit the scanned image. Additionally, the UI control unit 1201 has a Web browser function and performs OAuth authentication processing via the authorization server 105 and the resource server 106. Note that the UI control unit 1201 is an example of a processing means.

The scanner control unit 1202 is a software module that controls the operation of the scanner 205. For example, the scanner control unit 1202 pulls the document into a document table and provides an instruction for reading the image to the scanner 205 that reads the image of the document by using photoelectric conversion.

The transmission control unit 1203 is a software module that controls image transmission such as e-mail transmission, file transmission, and FAX transmission. Additionally, the transmission control unit 1203 transmits image data by the invoking of an external API as required. The transmission control unit 1203 is an example of a transmission means.

In the following description, a function for transmitting mails by reading one original document and invoking the mail transmission API of the resource server 106 by OAuth authentication (mail function) will be described as an example. Additionally, in the sequence shown in FIG. 12 and FIG. 13, it is assumed that the MFP 101 has already acquired the access token and the refresh token.

First, based on the operation unit 204, the UI control unit 1201 detects that the user has performed a login operation on the login screen (FIG. 3) (S1201). When the user successfully logs in to the MPF 101, the UI control unit 1201 displays a home screen (FIG. 4) on the LCD display panel 301 (S1202).

When the user presses the “Scan” button 402 on the home screen, the UI control unit 1201 detects that the “Scan” button 402 has been pressed (S1203). When the pressing of the “Scan” button 402 has been detected, the UI control unit 1201 displays an operation screen (FIG. 5) of the SEND application on the LCD display panel 301 (S1204). When the user specifies a mail destination (e-mail address) as a transmission destination from the operation unit 204, the UI control unit 1201 detects a mail destination specified as a transmission destination (S1205).

When detecting the specification of the mail destination, the UI control unit 1201 transmits a request for verifying the validity of the access token to the resource server 106 (S1206). As a result, the process for verifying the validity of the access token starts. The request for verifying the validity of the access token includes the access token that has been read from the hard disk 208 by the UI control unit 1201.

In the sequence shown in FIG. 12 and FIG. 13, the UI control unit 1201 performs the above validity verification request at the timing when the specification of the mail destination has been detected as a destination of the image data. However, the timing for performing the validity verification request is not limited to the above example. For example, the UI control unit 1201 may perform the validity verification request at the timing at which a login has been performed to the MPF 101 (S1202). For example, the UI control unit 1201 may perform the validity verification request at a timing (S1203) at which an input of an instruction (pressing of the “Scan” button 402) to transition to the operation screen of the SEND application (FIG. 5) has been received. For example, the UI control unit 1201 may perform the validity verification request at a timing (S1211 to be described below) at which an operation for executing the scan processing (for example, pressing of the start key 303) to be described below has been received.

When the resource server 106 receives the validity verification request of the access token, it verifies the validity of the access token, and provides a notification about the result to the UI control unit 1201 (S1207). Here, the UI control unit 1201 switches the operation depending on whether the notification about the result received from the resource server 106 in step S1207 is a valid notification or an invalid notification. In the sequence shown in FIG. 12 and FIG. 13, the case in which the UI control unit 1201 receives the invalid notification of the access token from the resource server 106 will be described.

When receiving the invalid notification of the access token, the UI control unit 1201 transmits a request for reissuing the access token by using the refresh token to the authorization server 105 (S1208). The refresh token is included in the request for reissuing the access token.

When the authorization server 105 receives the request for reissuing the access token, it verifies the request for reissuing the access token by using the refresh token, and provides a notification about the result to the UI control unit 1201 (S1209). Here, the UI control unit 1201 switches the operation depending on whether the notification about the result received from the authorization server 105 in step S1209 is a success notification or a failure notification. In the sequence shown in FIG. 12 and FIG. 13, a case in which the UI control unit 1201 has received the failure notification from the authorization server 105 will be described.

In contrast, when the user provides a notification about a transmission instruction from the operation unit 204, the UI control unit 1201 detects the user's operation of the transmission instruction (S1210). When the UI control unit 1201 detects the operation of the transmission instruction, it performs a scanning start request on the scanner control unit 1202 (S1211). Subsequently, the UI control unit 1201 displays the scan in-progress screen (FIG. 7) on the LCD display panel 301 (S1212).

Upon receiving a scanning start request from the UI control unit 1201, the scanner control unit 1202 operates the scanner 205 to scan an original (S1213). Upon completion of scanning, the scanner control unit 1202 provides a notification about completion of scanning to the UI control unit 1201 (S1214).

Upon receiving the notification about completion of scanning from the scanner control unit 1202, the UI control unit 1201 causes the LCD display panel 301 to display a screen showing that the reissue of the access token by using the refresh token has failed (FIG. 9) (S1215).

Here, the UI control unit 1201 determines whether or not to reissue the access token by login authentication, and depending on the determination, it switches the operation. The determination is performed based on which of the operations of the “YES” button 901 or the “NO” button 902 has been received on the screen showing that the reissue of the access token has failed (FIG. 9). Specifically, if the operation of the “YES” button 901 has been received, the UI control unit 1201 determines that the reissue of the access token by login authentication will be performed. In contrast, if the operation of the “NO” button 902 has been received, the UI control unit 1201 determines not to reissue the access token by login authentication. In the sequence shown in FIG. 12 and FIG. 13, the case in which the UI control unit 1201 reissues the access token by login authentication will be described.

When the user reissues the access token by login authentication, the UI control unit 1201 transmits a request for login authentication to the resource server 106 (S1216). Upon receiving the request for login authentication, the resource server 106 transmits a redirect URL for the authorization server 105 for login authentication to the UI control unit 1201 (S1217).

The UI control unit 1201 communicates with the authorization server 105 for requesting the page of the redirect URL destination received from the resource server 106 (S1218). Upon receiving the request for the page of the redirect URL destination, the authorization server 105 transmits the requested login authentication page to the UI control unit 1201 (S1219).

When receiving the login authentication page from the authorization server 105, the UI control unit 1201 causes the LCD display panel 301 to display a screen of the received login authentication page (FIG. 10) (S1220). When the user performs a login authentication operation on the login authentication screen, the UI control unit 1201 detects the login authentication operation by the user and performs communication with the authorization server 105 for login authentication (S1221). The communication includes authentication information necessary for login authentication (for example, a user name and a password).

The authorization server 105 performs the authentication processing based on the authentication information received from the UI control unit 1201, and provides a notification about the authentication result to the UI control unit 1201 (S1222). Here, the UI control unit 1201 switches the operations depending on whether the notification about the authentication result received from the authorization server 105 is a success notification or a failure notification. In the sequence shown in FIG. 12 and FIG. 13, the case in which the UI control unit 1201 has received the success notification as the authentication result from the authorization server 105 will be described.

If the authentication result is a success notification, the notification from the authorization server 105 includes an authorization page. When receiving the success notification about the authentication result from the authorization server 105, the UI control unit 1201 causes the LCD display panel 301 to display an authorization screen (FIG. 11) based on the information about the authorization page (S1223) for which notification has been provided.

When the user performs an authorization operation (operation of the “Permitted” button 1101) on the authorization screen, the UI control unit 1201 detects an authorization operation from the user and transmits an authorization request to the authorization server 105 (S1224). Upon receiving the authorization request, the authorization server 105 provides a notification about the authorization result to the UI control unit 1201 (S1225). Here, the UI control unit 1201 switches the operations depending on whether the notification about the authorization result received from the authorization server 105 is a success notification or a failure notification. In the sequence shown in FIG. 12 and FIG. 13, the case in which the UI control unit 1201 receives the success notification as the authorization result from the authorization server 105 will be described.

If the authorization result is a success notification, the notification from authorization server 105 includes the access token and the refresh token generated by authorization server 105. Upon receiving the success notification as the authorization result from the authorization server 105, the UI control unit 1201 transmits the mail transmission request to the transmission control unit 1203 (S1226). In contrast, the UI control unit 1201 causes the LCD display panel 301 to display a job reception completion screen (FIG. 8) related to the transmission job (S1227).

Upon receiving the mail transmission request from the UI control unit 1201, the transmission control unit 1203 performs communication for invoking the mail transmission API to the resource server 106 (S1228). An access token is included in the communication for invoking the mail transmission API.

When the mail transmission API is invoked, the resource server 106 performs mail transmission processing on the mail server 103 and provides a notification about the result of the mail transmission API to the transmission control unit 1203 (S1229). Upon receiving the notification about the result of the mail transmission API, the transmission control unit 1203 provides a notification about the mail transmission result to the UI control unit 1201 (S1230). The description of FIG. 12 and FIG. 13 is now completed.

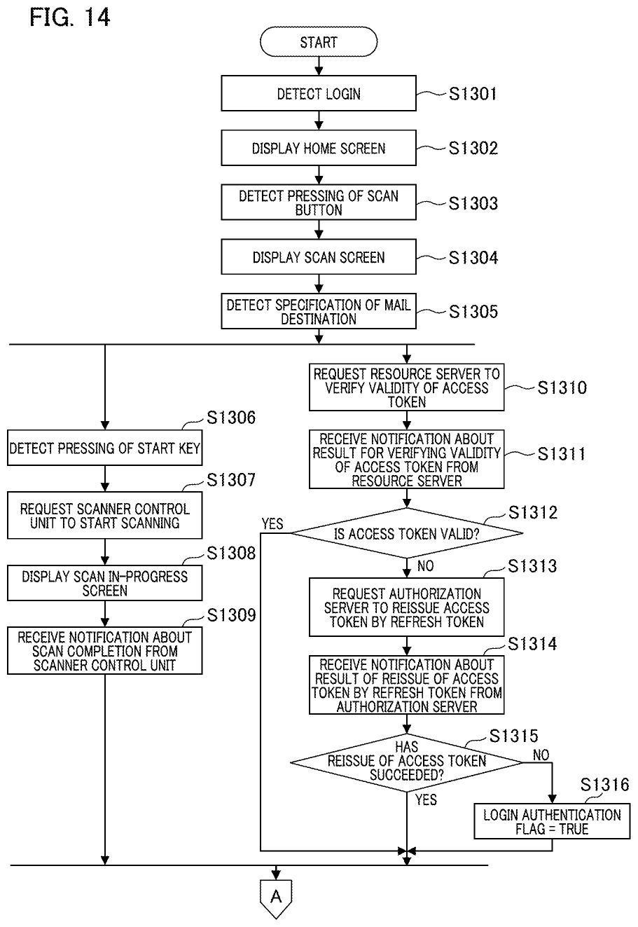

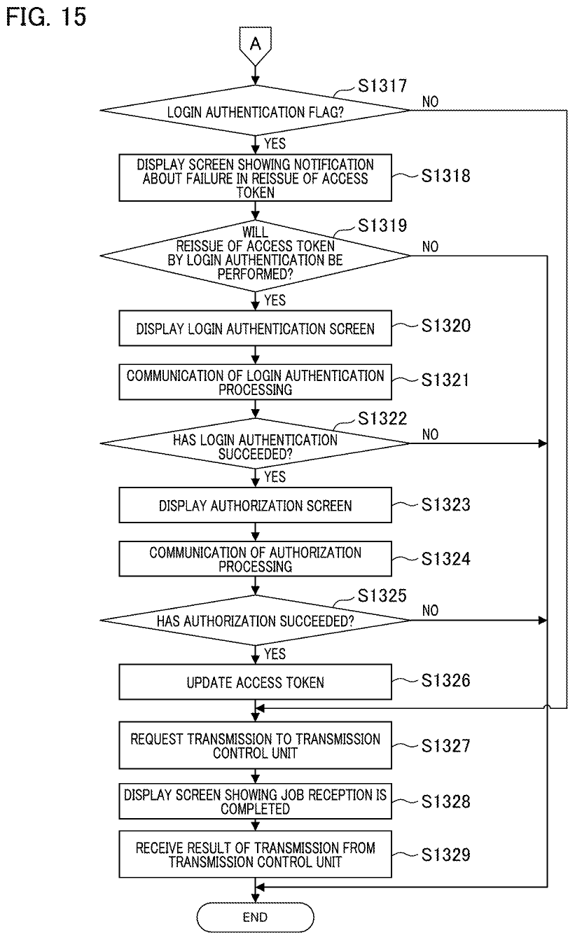

FIG. 14 and FIG. 15 are flow charts illustrating an operation example of the UI control unit 1201 in the first embodiment. In step S1301, the UI control unit 1201 detects that the user has performed a login operation. In step S1302, the UI control unit 1201 causes the LCD display panel 301 to display the home screen (FIG. 4).

In step S1303, the UI control unit 1201 detects that the user has pressed the “Scan” button 402 shown in FIG. 4. In step S1304, the UI control unit 1201 causes the LCD display panel 301 to display the operation screen of the SEND application (FIG. 5). In step S1305, the UI control unit 1201 detects that the user has specified a mail destination.

Here, in the flowchart of FIG. 14, the UI control unit 1201 executes the processes from steps from S1306 to S1309 and the processes from steps S1310 to S1316 in parallel. First, the processes from steps S1306 to S1309 will be described.

In step S1306, the UI control unit 1201 detects that the user has pressed the start key 303. In step S1307, the UI control unit 1201 transmits a scanning start request to the scanner control unit 1202.

In step S1308, the UI control unit 1201 causes the LCD display panel 301 to display a scan in-progress screen (FIG. 7) during execution of scanning. In step S1309, upon completion of scanning, the UI control unit 1201 receives the scan completion notification from the scanner control unit 1202.

Next, the processes from steps S1310 to S1316 will be described. In step S1310, the UI control unit 1201 transmits a request for verifying the validity of the access token to the resource server 106. In step S1311, the UI control unit 1201 receives a notification about the result for verifying the validity of the access token from the resource server 106.

In step 1312, the UI control unit 1201 determines whether or not the access token is valid based on the notification about the result for verifying the validity of the access token. If the access token is valid (YES), the UI control unit 1201 completes the processes from steps S1310 to S1316. Note that, in this case, a login authentication flag is set to FALSE. In contrast, if the access token is invalid (NO), the process proceeds to step S1313.

In step S1313, the UI control unit 1201 transmits a request for reissuing the access token by using the refresh token to the authorization server 105. In step S1314, the UI control unit 1201 receives a notification about the result for reissuing the access token by using the refresh token from the authorization server 105.

In step 1315, the UI control unit 1201 determines whether or not the reissue of the access token by using the refresh token has succeeded based on the notification about the result of the reissue of the access token. If the reissue has succeeded (YES), the UI control unit 1201 completes the processes from steps S1310 to S1316. Note that in this case, the login authentication flag is set to FALSE. In contrast, if the reissue has failed (NO), the process proceeds to step S1316. In step S1316, the UI control unit 1201 sets the login authentication flag to TRUE.

When the processes from steps S1306 to S1309 and the processes from steps S1310 to S1316 are both completed, the process proceeds to the process of step S1317. In step S1317, the UI control unit 1201 determines whether or not the login authentication flag is TRUE. If the login authentication flag is TRUE (YES), the process proceeds to step S1318. In contrast, if the login authentication flag is FALSE (NO), the process proceeds to step S1327.

In step S1318, the UI control unit 1201 causes the LCD display panel 301 to display the screen showing that the reissue of the access token by the refresh token has failed (FIG. 9) (S1318).

In step S1319, the UI control unit 1201 determines whether or not to reissue the access token by login authentication. Specifically, when the UI control unit 1201 receives the operation of the “YES” button 901 on the screen of FIG. 9, it determines that the reissue of the access token by login authentication will be performed. In contrast, when the UI control unit 1201 receives the operation of the “NO” button 902 on the screen shown in FIG. 9, it determines not to reissue the access token by login authentication.

When the “YES” button 901 is operated to reissue the access token by login authentication (YES), the process proceeds to step S1320. In contrast, if the “NO” button 902 is operated and the reissue of the access token by login authentication is not performed (NO), the UI control unit 1201 ends the processes of FIG. 14 and FIG. 15.

In step S1320, the UI control unit 1201 causes the LCD display panel 301 to display the login authentication screen (FIG. 10). In step S1321, when the UI control unit 1201 receives the login authentication operation on the login authentication screen, it performs communication for the login authentication processing to the authorization server 105.

In step S1322, the UI control unit 1201 determines whether or not the login authentication processing has succeeded based on the notification about the authentication result received from the authorization server 105. If the login authentication processing has succeeded (YES), the process proceeds to step S1323. In contrast, if the login authentication processing has failed (NO), the UI control unit 1201 ends the processes of FIG. 14 and FIG. 15.

In step S1323, the UI control unit 1201 causes the LCD display panel 301 to display an authorization screen (FIG. 11). In step S1324, when the UI control unit 1201 receives the authorization operation on the authorization screen, it communicates with the authorization server 105 for the authorization processing.

In step S1325, the UI control unit 1201 determines whether or not the authorization processing has succeeded based on the notification about the authorization result received from the authorization server 105. If the authorization processing has succeeded (YES), the process proceeds to step S1326. In contrast, if the authorization processing has failed (NO), the UI control unit 1201 ends the processes of FIG. 14 and FIG. 15.

In step S1326, the UI control unit 1201 updates the access token stored in the hard disk 208 when the authorization processing has succeeded. In step S1327, the UI control unit 1201 transmits a mail transmission request to the transmission control unit 1203.

In step S1328, the UI control unit 1201 causes the LCD display panel 301 to display the job reception completion screen (FIG. 8) related to the transmission job. In step S1329, the UI control unit 1201 receives the notification about the mail transmission result from the transmission control unit 1203, and then ends the processes of FIG. 14 and FIG. 15. The description of FIG. 14 and FIG. 15 is now completed.

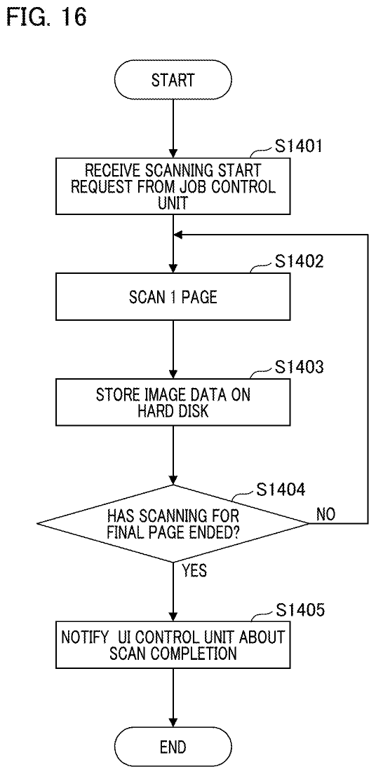

FIG. 16 is a flowchart illustrating an operation example of the scanner control unit 1202 in the first embodiment. In step S1401, the scanner control unit 1202 receives a scanning start request from the UI control unit 1201. In step S1402, the scanner control unit 1202 starts the scanning operation by the scanner 205 and scans the document by one page. In step S1403, the scanner control unit 1202 stores the scanned image data in the hard disk 208.

In step S1404, the scanner control unit 1202 determines whether or not scanning of the final page of the document has been completed. When the scanning of the final page has been completed (YES), the process proceeds to step S1405. In contrast, if the scanning of the final page has not been completed (NO), the scanner control unit 1202 returns to step S1402 and repeats the above process. In step S1405, the scanner control unit 1202 provides a notification about the completion of scanning to the UI control unit 1201 and then ends the process of FIG. 16.

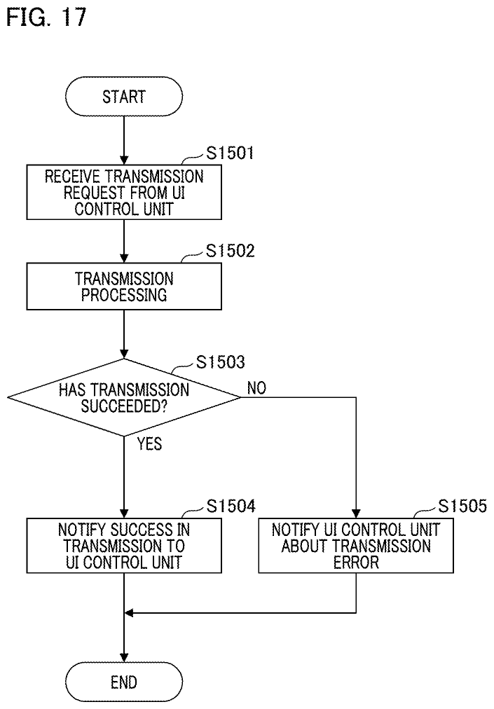

FIG. 17 is a flowchart showing an operation example of the transmission control unit 1203 in the first embodiment. In step S1501, the transmission control unit 1203 receives a mail transmission request from the UI control unit 1201. In step S1502, the transmission control unit 1203 performs the mail transmission processing to the specified transmission destination. This mail transmission processing is performed by calling the mail transmission API of the resource server 106.

In step S1503, the transmission control unit 1203 determines whether or not mail transmission has succeeded based on the result notification of the mail transmission API. If the mail transmission has succeeded (YES), the process proceeds to step S1504. In contrast, if the mail transmission has failed (NO), the process proceeds to step 1505. In step S1504, the transmission control unit 1203 provides a notification about the transmission success to the UI control unit 1201, and then ends the process of FIG. 17. In step S1505, the transmission control unit 1203 provides a notification about a transmission error to the UI control unit 1201, and then ends the process of FIG. 17.

In the MPF 101 according to the first embodiment, after the access token corresponding to the login user has been verified (S1206 to S1209), a mail function by using the mail transmission API of the resource server 106 can be used. The UI control unit 1201 starts the processing for verifying the validity of the access token corresponding to the login user between the success of the login to the MPF 101 (S1202) and the completion of the scanning processing that follows the scanning instruction in accordance with the login (S1214). The transmission control unit 1203 transmits mail data including image data obtained by scanning processing (S1213) to a mail server by using a mail function in accordance with the result for the verification of the access token. Thus, in the first embodiment, the processing for verifying the validity of the access token starts at least before the scanning processing is completed. Therefore, the total processing time from the scanning to the completion of transmission can be restrained as compared with the case in which the authorization processing by the access token is performed after the scanning is completed.

### Second Embodiment

In the second embodiment, a configuration will be described in which the login authentication screen and the authorization screen are displayed before the user logs out if the reissue of the access token by the refresh token is required in OAuth authentication.

Here, since the hardware configuration of the image processing system in the second embodiment is the same as that in the first embodiment, the redundant description thereof will be omitted. Additionally, since the display screen of the LCD display panel 301 in the second embodiment is the same as that in the first embodiment, the redundant description thereof will be omitted. Additionally, in the second embodiment, the software modules of the MFP 101 include the UI control unit 1201, the scanner control unit 1202, and the transmission control unit 1203 as in the first embodiment. Among these, the operations of the scanner control unit 1202 and the transmission control unit 1203 are the same as those in the first embodiment, and therefore the redundant description will be omitted.

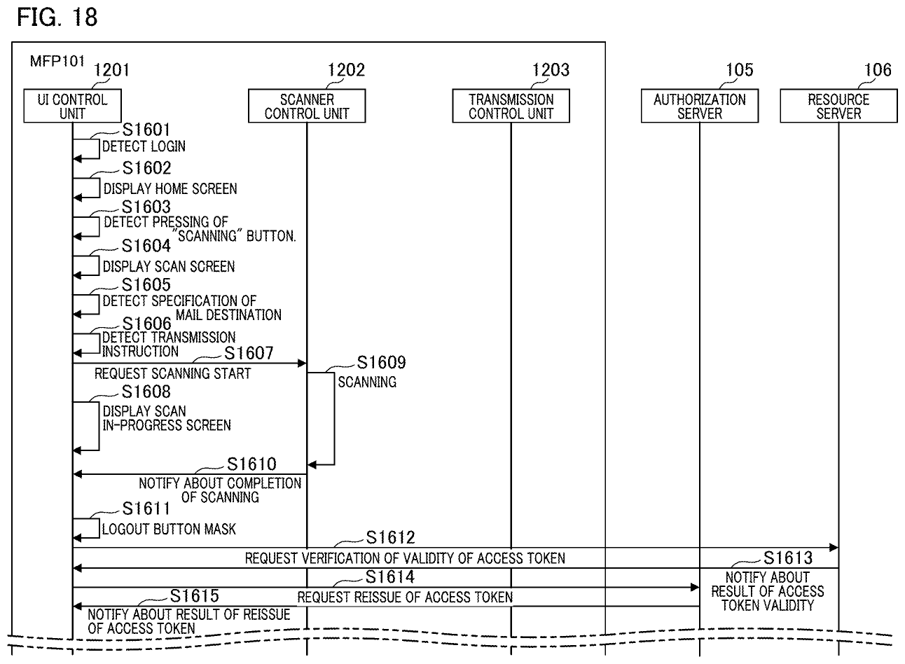

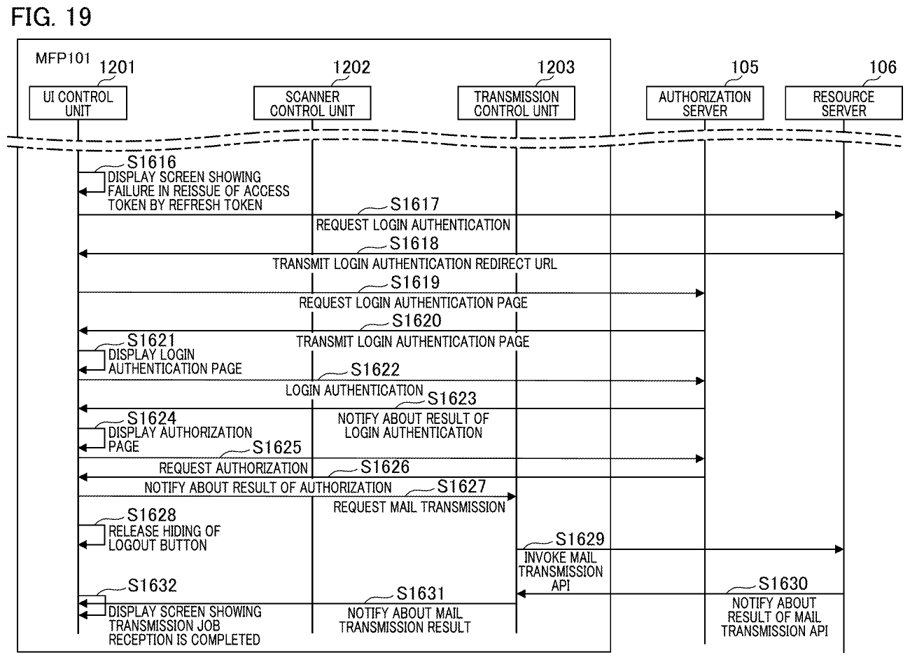

FIG. 18 and FIG. 19 illustrate a command sequence between software modules installed on the MFP 101 according to the second embodiment. The operation of the software modules of the MFP 101 shown in FIG. 18 and FIG. 19 is realized by executing a program after the CPU 201 of the MFP 101 reads the program stored in the ROM 202 or the hard disk 208 into the RAM 203.

In the following description, a function of reading one document and transmitting mails by invoking the mail transmission API of the resource server 106 by OAuth authentication (mail function) will be described as an example. Additionally, in the sequence shown in FIG. 18 and FIG. 19, it is assumed that the MFP 101 has already acquired the access token and the refresh token in advance.

The operations from step S1601 to step S1605 in FIG. 18 are the same as the operations from step S1201 to step S1205 in FIG. 12 described in the first embodiment, and therefore redundant description will be omitted. When the user performs a transmission instruction from the operation unit 204, the UI control unit 1201 detects the operation of the transmission instruction of the user (S1606).

When detecting the operation of the transmission instruction, the UI control unit 1201 performs a scanning start request at the scanner control unit 1202 (S1607). Then, the UI control unit 1201 causes the LCD display panel 301 to display the scan in-progress screen (FIG. 7) (S1608).

Upon receiving a scanning start request from the UI control unit 1201, the scanner control unit 1202 operates the scanner 205 to scan the document (S1608). When scanning is completed, the scanner control unit 1202 provides a notification about scanning completion to the UI control unit 1201 (S1610).

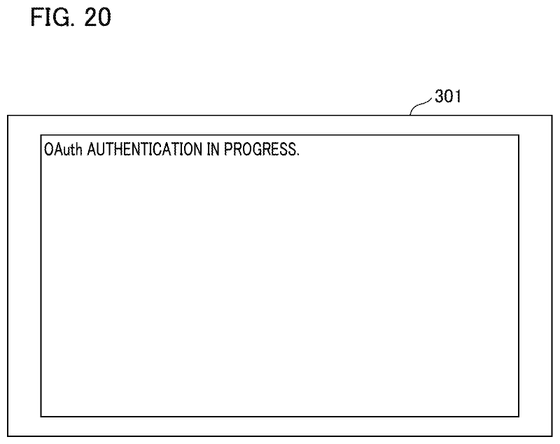

When the UI control unit 1201 receives the scan completion notification from the scanner control unit 1202, it causes the LCD display panel 301 to display an OAuth authentication in-progress screen (FIG. 20) (S1611). Unlike the scan in-progress screen (FIG. 7), the OAuth authentication in-progress screen shown in FIG. 20 does not display the “Logout” button (703). Thus, when the OAuth authentication in-progress screen is displayed, the “Logout” button is shielded, and the user cannot operate the “Logout” button.

The operations from steps S1612 to S1615 in FIG. 18 are the same as those from steps S1206 to S1209 in FIG. 12 described in the first embodiment. The operations from steps S1616 to S1626 in FIG. 19 are the same as those from steps S1215 to S1225 in FIG. 13 described in the first embodiment. Therefore, the redundant description related to the operations from step S1612 to step S1626 will be omitted.

Upon receiving the success notification as the authorization result from the authorization server 105, the UI control unit 1201 transmits a mail transmission request to the transmission control unit 1203 (S1627). In contrast, the UI control unit 1201 hides the OAuth authentication in-progress screen on the LCD display panel 301 in order to release the shielding of the logout button (S1628).

Upon receiving the mail transmission request from the UI control unit 1201, the transmission control unit 1203 communicates with the resource server 106 to call the mail transmission API (S1629). An access token is included in the communication for calling the mail transmission API.

When the mail transmission API is called, the resource server 106 performs the mail transmission processing and provides a notification about the result of the mail transmission API to the transmission control unit 1203 (S1630). Upon receiving the notification about the result of the mail transmission API, the transmission control unit 1203 provides a notification about the mail transmission result to the UI control unit 1201 (S1631). The UI control unit 1201 causes the LCD display panel 301 to display a job reception completion screen related to the transmission job (FIG. 8) (S1632). The description of FIG. 18 and FIG. 19 is now completed.

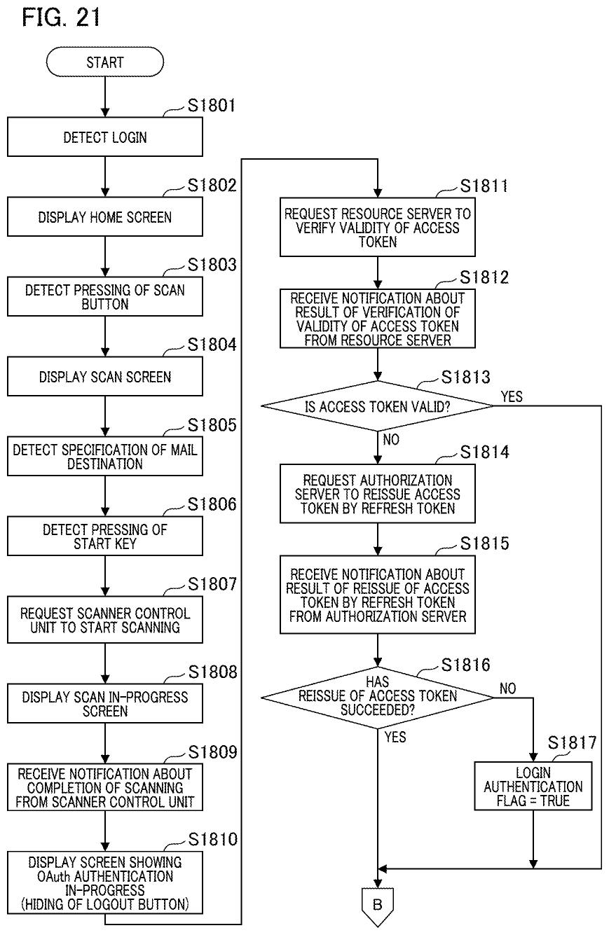

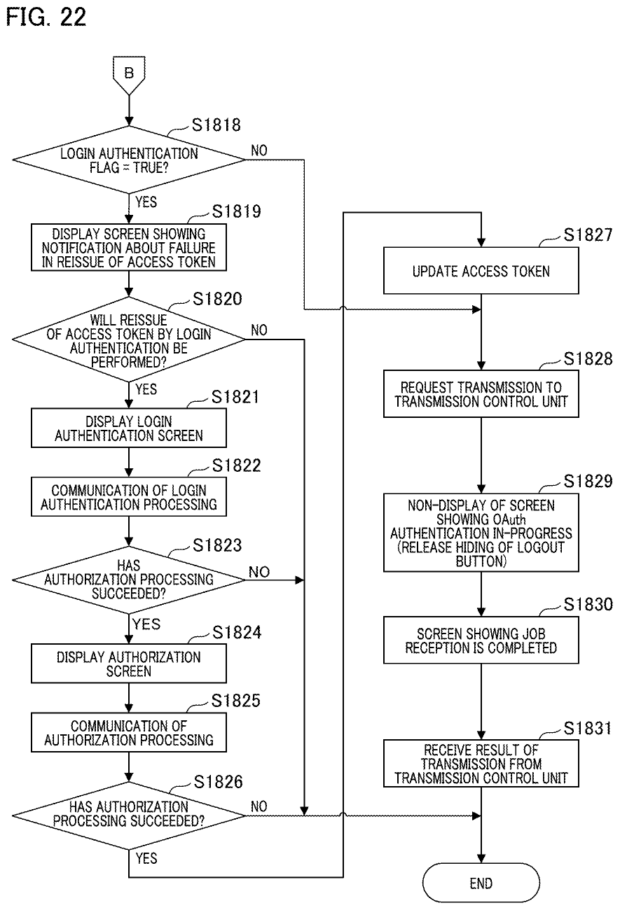

FIG. 21 and FIG. 22 are flow charts showing an operation example of the UI control unit 1201 in the second embodiment. The operations from step S1801 to step S1809 in FIG. 21 are the same as those from step S1801 to step S1809 in FIG. 14 described in the first embodiment, and therefore redundant description will be omitted.

In step S1810, the UI control unit 1201 causes the LCD display panel 301 to display the OAuth authentication in-progress screen (FIG. 20), and shields the logout button. The operations from step S1811 to step S1817 in FIG. 21 are the same as those from step S1310 to step S1316 in FIG. 14 described in the first embodiment. Additionally, the operation from step S1818 to step S1828 in FIG. 22 are the same as those from step S1317 to step S1327 in FIG. 15 described in the first embodiment. Therefore, the redundant description of the operation from step S1811 to step S1828 will be omitted.

In step S1829, the UI control unit 1201 hides the OAuth authentication in-progress screen on the LCD display panel 301. Thus, the shielding of the logout button is released. Since the operations of steps S1830 and S1831 in FIG. 22 are the same as those of steps S1328 and S1329 in FIG. 15 described in the first embodiment, redundant description will be omitted. The description of FIG. 21 and FIG. 22 is now completed.

If the reissue of the access token by using the refresh token has failed during verification of the validity of the access token, an operation on the login authentication screen (FIG. 10) and the authorization screen (FIG. 11) is required. At this time, when the user logs out of the MPF 101, the login authentication screen and the authorization screen cannot be presented, so that the job being executed becomes a transmission error. In the second embodiment, the user is prevented from being logged out from the MPF 101 during OAuth authentication by making a manner in which the logout button cannot be pressed when the validity of the access token corresponding to the login user is being verified. Therefore, in the second embodiment, if the reissue of the access token has failed, the login authentication screen and the authorization screen can be presented to the user without being logged out, and the reissue of the access token by login authentication can be prompted.

### OTHER EMBODIMENTS

In the second embodiment, the means for shielding the logout button is not limited to displaying the OAuth authentication in-progress screen (FIG. 20). For example, not receiving the operation of the logout button on the LCD display panel 301 after performing display processing such as graying out the logout button is possible.

Also in the first embodiment, if the validity of the access token corresponding to the login user is being verified (S1206 to S1209), the UI control unit 1201 may execute the control of making the logout button inoperable. The control in a state in which the logout button cannot be operated includes, for example, display processing that grays out the logout button and display switching to a screen on which the logout button is not displayed. Thus, in the first embodiment as well, if the reissue of the access token has failed, the login authentication screen and the authorization screen can be presented to the user without being logged out.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-070466, filed Apr. 2, 2019 which is hereby incorporated by reference wherein in its entirety.

What is claimed is:

1. An image processing apparatus that supports a mail function which is able to be used based on a verification of an access token corresponding to a login user, the image processing apparatus comprising:
a memory storing instructions; and
a processor executing the instructions causing the image processing apparatus to:
start processing for verifying the validity of an access token corresponding to the login user between the success in login to the image processing apparatus and the completion of scanning processing that follows a scanning instruction corresponding to the login; and
transmit mail data including image data obtained by the scanning processing to a mail server by using the mail function in accordance with the result for the verification of the access token.

2. The image processing apparatus according to claim 1,
wherein, in the processing, the processing for verifying the validity of the access token starts at a timing at which a mail address is specified to serve as a destination of the image data obtained by the scanning processing.

3. The image processing apparatus according to claim 1,
wherein, in the processing, the processing for verifying the validity of the access token starts at the timing at which a login to the image processing apparatus has succeeded.

4. The image processing apparatus according to claim 1,
wherein, in the processing, the processing for verifying the validity of the access token starts at the timing of receiving input of an instruction to transition to a screen for the scan instruction.

5. The image processing apparatus according to claim 1,
wherein, in the processing, the processing for verifying the validity of the access token starts at the timing of receiving an operation for executing the scanning processing.

6. The image processing apparatus according to claim 1,
wherein the processing for verifying the validity of the access token is executed in parallel with the execution of the scanning processing.

7. The image processing apparatus according to claim 1,
wherein, in the processing, if the verification of the access token corresponding to the login user has failed, processing for reissuing the access token by using a refresh token is executed, and
wherein, in the transmission, the mail data including the image data is transmitted to a mail server by using the mail function, by using the reissued access token.

8. The image processing apparatus according to claim 7,
wherein, in the processing, if the reissue of the access token by using the refresh token has failed, processing for login authentication of the login user is executed, and
wherein, in the transmission, the mail data including the image data is transmitted to the mail server by using the mail function, by using the access token issued based on the login authentication.

9. The image processing apparatus according to claim 8,
wherein, in the processing, authorization processing for authorizing the use of the mail function by the login authentication is further executed if the login authentication has succeeded, and
wherein, in the transmission, the mail data including the image data is transmitted to the mail server by using the mail function, by using the access token issued based on the login authentication and the authorization processing.

10. A method in an image processing apparatus that supports a mail function which is able to be used based on a verification of an access token corresponding to a login user, the method comprising:
starting processing for verifying the validity of the access token corresponding to the login user between success in login to the image processing apparatus and completion of scanning processing in accordance with a scanning instruction corresponding to the login; and
transmitting mail data including image data that has been obtained by the scanning processing to a mail server by using the mail function, in accordance with the result for the verification of the access token.

11. A non-transitory storage medium on which is stored a computer program for making a computer of an image processing apparatus execute:
starting processing for verifying the validity of an access token corresponding to a login user between success in login to the image processing apparatus and the completion of scanning processing in accordance with a scanning instruction corresponding to the login; and
transmitting mail data including image data that has been obtained by the scanning processing to a mail server by using the mail function in accordance with the result for the verification of the access token.
